(19) United States
(12) Patent Application Publication
(10) Pub. No.: US 2007/0058216 A1
(43) Pub. Date: Mar. 15, 2007

(54) Scanner

(75) Inventors: Tien Chen Chen, Taipei (TW); Chia Min Wang, Taichung (TW)

Correspondence Address: QUINTERO LAW OFFICE, PC, 2210 MAIN STREET, SUITE 200, SANTA MONICA, CA, 90405, US

(73) Assignee: LITE-ON TECHNOLOGY CORPORATION, TAIPEI (TW)

(21) Appl. No.: 11/442,583

(22) Filed: May 26, 2006

(30) Foreign Application Priority Data
Sep. 15, 2005 (TW) TW94131794

(51) Int. Cl. H04N 1/04

(52) U.S. Cl. 358/474

(57) ABSTRACT

A scanner. A scanner comprises a glass plate bearing a scanned object, a light machine having a cover under the glass plate and a light source disposed in the cover and emitting light to the glass plate, at least one pad mounted on the cover and positioned between the cover and the glass plate, and a biasing mechanism disposed in the light machine and biasing the cover. The cover is biased to maintain contact with the glass plate via the pad.

### BACKGROUND

The invention relates to a scanner, and in particular to a scanner of high scanning quality.

In a conventional scanner, a predetermined gap, such as 3 mm, is set between a glass plate bearing a scanned object and a light machine, whereby the glass plate is avoided to deform and press on the light machine when a heavy object, such as a book, is on the glass plate. On the other hand, the gap causes a considerable distance between the light machine and the scanned object, which may reduce the intensity of light reaching the scanned object. Furthermore, when the glass plate deforms, the intensity of light reaching the scanned object may become non-uniform.

### SUMMARY

An embodiment of a scanner of the invention comprises a glass plate bearing a scanned object, a light machine having a cover under the glass plate and a light source disposed in the cover and emitting light to the glass plate, at least one pad mounted on the cover and positioned between the cover and the glass plate, and a biasing mechanism disposed in the light machine and biasing the cover. The cover is biased to maintain contact with the glass plate via the pad.

The biasing mechanism comprises a compression spring biasing the cover. The biasing mechanism comprises a guide post disposed on the cover, and the compression spring joins the guide post. The material of the pad is wear-resistant. The material of the pad comprises polyoxymethylene (POM).

### BRIEF DESCRIPTION OF THE DRAWINGS

The invention can be more fully understood by reading the subsequent detailed description and examples with references made to the accompanying drawings, wherein:

FIG. 1 is a front view of an embodiment of a scanner of the invention;

FIG. 2 is a perspective view of a light machine of the invention; and

FIG. 3 is a cross section of portion A of FIG. 1.

### DETAILED DESCRIPTION

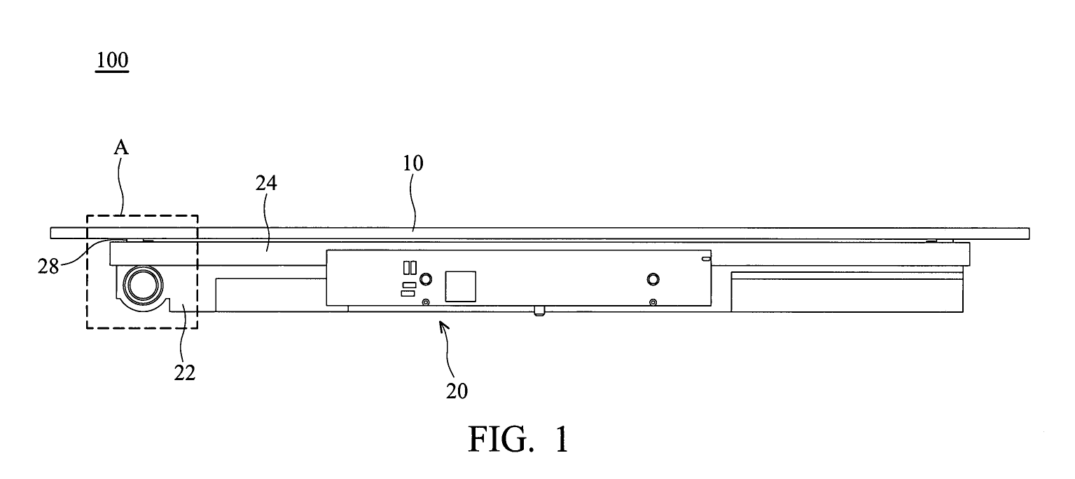

Referring to FIG. 1, a scanner 100 comprises a glass plate 10 and a light machine 20. The glass plate 10 bears a scanned object. The light machine 20 is movably disposed under the glass plate 10 to provide scanning light.

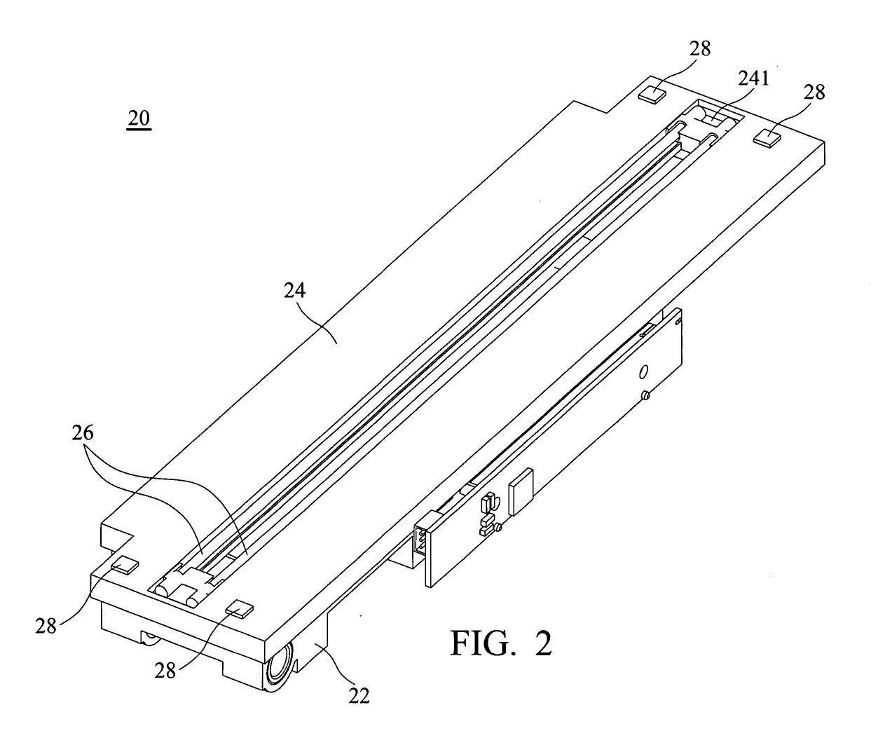

Referring to FIG. 2, the light machine 20 comprises a main body 22, a cover 24, a fluorescent tube (light source) 26, and pads 28. The cover 24 covering the main body 22 has a depression 241 accommodating the fluorescent tube 26. Light from the fluorescent tube 26 reaches the glass plate 10 and the scanned object for scanning. Pads 28 (this embodiment has four pads) are disposed on the side of the cover 24 facing the glass plate 10. The cover 24 contacts the glass plate 10 via the pads 28.

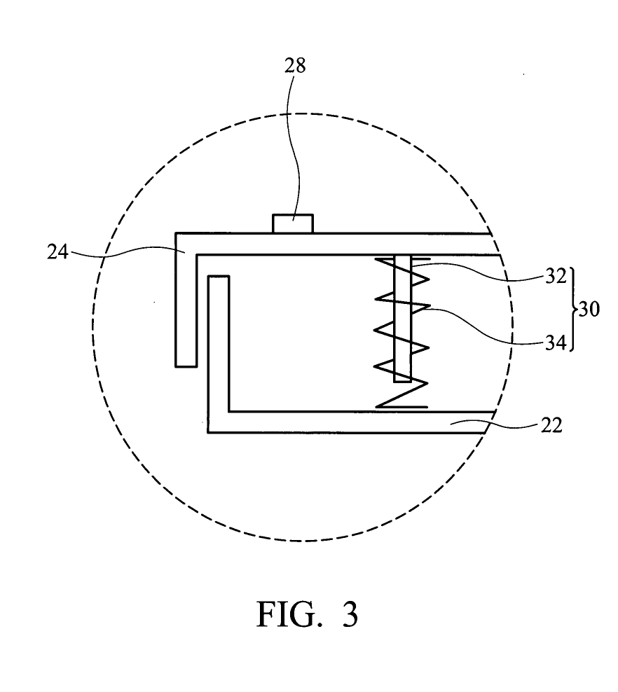

Referring to FIG. 3, the cover 24 is joined to the main body 22 by a biasing mechanism 30 and movable with respect to the main body 22. The biasing mechanism 30 comprises a guide post 32 and a compression spring 34. The guide post 32 extends from the cover 24 and toward the main body 22. The compression spring 34 is mounted on the guide post 32 with one end fixed to the main body 22 and the other end biasing the bottom of the cover 24. The potential of the compression spring 34 biases the cover 24 to contact the glass plate 10 via the pads 28 as shown in FIG. 1.

In this way, the cover 24 maintains tight contact with the glass plate 10, whereby the fluorescent tube 26 is closer to the scanned object such that the light intensity reaching the scanned object is larger than a conventional scanner. Even if the glass plate 10 deforms due to a heavy object, as the light machine 20 maintains contact with the glass plate 10, uniform light intensity is provided.

As the pads 28 must contact the glass plate 10 when the light machine 20 moves, wear-resistant material is preferable. In this embodiment, material of the pads 28 comprises polyoxymethylene (POM) which has excellent wear proof and lubrication characteristics and has high rigidity. However, the material of the pads 28 is not limited to POM, other elements, such as nylon-6(Ny6) or nylon-66(Ny66), are also applicable.

The number of the pads 28 is unlimited and can be one or more. The positions of the pads 28 are arbitrary according to requirements. In addition, the biasing mechanism is not limited to the compression spring, other elements capable of biasing the cover 24, such as sheet metal, are also applicable.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A scanner, comprising:
a glass plate bearing a scanned object;
a light machine having a cover under the glass plate and a light source disposed in the cover and emitting light to the glass plate;
at least one pad mounted on the cover and positioned between the cover and the glass plate; and
a biasing mechanism disposed in the light machine and biasing the cover, whereby the cover maintains contact with the glass plate via the pad.

2. The scanner as claimed in claim 1, wherein the biasing mechanism comprises a compression spring biasing the cover.

3. The scanner as claimed in claim 2, wherein the biasing mechanism comprises a guide post disposed on the cover, and the compression spring joins the guide post.

4. The scanner as claimed in claim 1, wherein the material of the pad is wear-resistant.

5. The scanner as claimed in claim 4, wherein the material of the pad comprises polyoxymethylene (POM), nylon-66(Ny66), or nylon-6(Ny6).
